(19) United States
(12) Patent Application Publication
(10) Pub. No.: US 2026/0261567 A1
(43) Pub. Date: Sep. 3, 2026

(54) Distributed Zero-Trust Architecture in a Telecommunications Network

(71) Applicant: Telefonaktiebolaget LM Ericsson (publ), Stockholm (SE)

(72) Inventors: Hichem Sedjelmaci, Cergy (FR); lrenea Renuncio Mateos, Nuevo Baztan, Eurovillas (ES); Scott Poretsky, Northborough, MA (US); Jonathan Olsson, Sollentuna (SE)

(21) Appl. No.: 19/155,815

(22) PCT Filed: Feb. 13, 2023
(86) PCT No.: PCT/IB2023/051298

§ 371 Date: Aug. 12, 2025

(51) Int. Cl. H04L 9/40

(52) U.S. Cl. CPC H04L 63/1416

(57) ABSTRACT

Methods for network security using deployable apps. An example method comprises, in each one or more first security agents in or associated with corresponding one or more deployable apps in the network, monitoring (810) network activity for suspected network attack reconnaissance and, in one or more second security agents in or associated with corresponding one or more deployable apps in the network, receiving (820) one or more reports of suspected network attack reconnaissance from any one or more of the first security agents. The method further comprises executing (830) an attack detection process, in response to at least one of the one or more reports. In various embodiments, various ones of the first and second security agents may be rApps in a real-time controller portion of the network and/or xApps in a non-real-time controller portion of the network.

### TECHNICAL FIELD

The present disclosure is related to security in telecommunications networks.

### BACKGROUND

The need for flexibility and scalability of cloud services in Radio Access Networks (RAN) operations is increasing. Vendors are looking to cloud-based RAN solutions to offer the openness and flexibility that operators and new verticals require. The Service Management and Orchestration (SMO) platforms and the RAN intelligent controller (RIC) architecture, which are both standardized by the O-RAN Alliance, are fundamental in creating an open framework designed to further improve the cost-effectiveness of Open RAN, as well as to expand supply chain diversity and promote innovation.

The Open RAN architecture introduces two new types of automation applications: rApps, which are specialized microservices running as functions of the Non-Real-Time (Non-RT) RIC; and xApps, running as functions of the (near-) Real-Time (RT) RIC. Today, rApps mainly interact with SMO through API services exposed at the R1 interface. An rApp subscribes to specific services (either consuming services or publishing services). The RT RIC handles events requiring action on a real-time or near-real-time basis, e.g., from 10 milliseconds (ms) to 1 second, and provides policy guidance back to the non-RT RIC through xApps. xApps operate to enhance the performance of the RAN, e.g., its spectrum efficiency.

The Non-RT RIC framework is designed to allow network operators and RAN software vendors the opportunity to integrate 3rd-party rApps for dedicated functions such as quality-of-service (QOS) optimization, mobility management, load balancing, and service level agreement (SLA) assurance. An additional functional area for rApps is security, which has not yet been addressed in the O-RAN specifications. Consequently, there currently is no specified architecture for security of rApps or xApps within the ORAN Alliance.

### SUMMARY

Security rApps can be enabled by the Non-RT RIC's broad network view, from which diverse data sets can be aggregated and correlated for automatic identification, protection, detection, response, and recovery of security events. A set of chained security rApps can thus perform data monitoring, detection, and reaction to security threats. Distribution of the rApps may depend on the architecture (distributed, hierarchical), meaning that there are opportunities to develop new rApp security architectures, including architectures leveraging rApps as part of a Zero Trust Architecture (ZTA) in O-RAN.

There are many possible security use cases for a “Security rApp.” One example is a security rApp that monitors other rApps, to detect malicious or compromised rApps. rApps can thus be used as a defense module to secure the SMO, as well as acting as a comprehensive defense module to detect malicious rApps.

Embodiments of the techniques, apparatuses, and systems described herein facilitate a ZTA for telecommunications networks, using deployable apps as secure and trusted security agents, e.g., using rApps and xApps in RIC Deployments. An example method for security, in a network, comprises monitoring network activity for suspected network attack reconnaissance, in each one or more first security agents in or associated with corresponding one or more deployable apps in the network. The example method further comprises receiving one or more reports of suspected network attack reconnaissance from any one or more of the first security agents, in one or more second security agents in or associated with corresponding one or more deployable apps in the network, and executing an attack detection process, in response to at least one of the one or more reports.

A corresponding example method for security may be implemented in a deployable app operating in a network. This method comprises receiving, from each of one or more security agents in or associated with corresponding one or more other deployable apps in the network, one or more reports of suspected network attack reconnaissance, and executing an attack detection process, in response to at least one of the one or more reports.

Another corresponding example method for security may similarly be implemented in a deployable app operating in a network. This method comprises monitoring network activity for suspected network attack reconnaissance and reporting suspected network attack reconnaissance to a security agent in or associated with a second deployable app, in response to detecting suspected network attack reconnaissance.

Variations of these methods are described in detail below, as are corresponding systems and nodes in which these nodes may be implemented.

### BRIEF DESCRIPTION OF THE DRAWINGS

FIG. 1 illustrates an example network comprising a centralized trusted entity, attack detection agents, and investigation security agents.

FIG. 2 illustrates an example architecture in which security agents are deployed in a non-real-time RIC and in a near-real-time RIC.

FIG. 3, FIG. 4, and FIG. 5 illustrate example architectural models for deploying security agents, according to various embodiments.

FIG. 6 is a process flow diagram illustrating an example method, according to some embodiments.

FIG. 7 is a process flow diagram illustrating another example method, according to some embodiments.

FIG. 8 is a process flow diagram illustrating another example method, according to some embodiments.

FIG. 9 and FIG. 10 are each process flow diagrams illustrating other example methods, according to some embodiments.

FIG. 11 illustrates an example apparatus configured to carry out one or more of the security techniques described herein.

### DETAILED DESCRIPTION

In K. Ramezanpour, et. al, “Intelligent Zero Trust Architecture for 5G/6G Tactical Networks: Principles, Challenges, and the Role of Machine Learning” (arXiv, 2021), the authors proposed a smart ZTA for the 5G network, to execute real-time monitoring of the security state of network assets, evaluating the risk of individual access requests, and deciding on access authorization using a dynamic trust algorithm. The envisioned architecture adopts a service-based architecture (SBA), like the 3GPP specification of 5G networks, by leveraging the open radio access network (O-RAN) architecture. However, this approach does not take into account that the deployed security agent securing the ZTA could be malicious and could provide false detection and decisions. The trustworthiness of the agent is assumed, leaving a potential security gap. In this research work the question of how to ensure a community of trusted security agents in the ZTA is therefore not addressed.

Other works have focused on protecting edge computing and the 5G core network from external attacks that aim to target the RAN with a goal to penetrate the edge and core networks. Artificial Intelligence (AI) security solutions have been developed to detect and respond against network attacks (such as botnet and DDoS), where the attacks detection and response actions are performed at edge/fog nodes. A weakness of these research proposals is that the centralization of all the AI security process (i.e., attacks detection and response) at the edge/fog node could degrade the network quality of service, e.g., by impacting the latency. This approach does not provide a zero-trust architecture to address situations in which the adversary is already inside the network, which could be the scenario when there is an untrusted rApp or a trusted rApp that has been compromised. Additionally, in the research, the hypothetical attacks focus on hacking the edge/fog node, which will result in an untrusted network. This approach fails to include a holistic view of the entire network and fails to account for all the different attack surfaces beyond the edge.

In M. Dryjański, “Toward Modular and Flexible Open RAN Implementations in 6G Networks: Traffic Steering Use Case and O-RAN xApps”, Sensors 2021, the author discusses security concepts in open radio access networks and presents ongoing O-RAN Alliance standardization activities in this context. The analysis is supported by a study of the traffic steering use case implemented in a modular way, following the open networking. Regarding the security aspect, security functions are proposed for xApps for RAN Intelligent Control (RIC). However, there are no details and explanations on how the security functions for xApps work, leaving this question unaddressed.

The shortcomings of the research summarized above are addressed by various embodiments of the techniques described herein, which, in several of the examples and techniques, use rApps and xApps as secure and trusted security agents in Open RAN deployments. It will be appreciated, however, that these techniques may be considered more generally—while the techniques are described here with regards to rApps and xApps, in an Open RAN context, they may be more generally understood as applying to the use of deployable applications (“apps”) more generally, where the rApp and xApp implementations described herein are examples of that more general approach.

The discussion here takes a generic approach to resolve a key problem: how to ensure ZTA in the context of telecommunications networks. The disclosed techniques are applied to a specific use case: ORAN and RIC deployments. In this use case, rApps and xApps are used as security agents.

There are two distinct problems that must be resolved in the context of this use case:
1. Detecting malicious or compromised rApps/xApps. Here, rApp/xApps refers to all types of apps, not limited to security apps.
2. Evaluating the confidence/trust in the measurements provided by security agents monitoring rApps/xApps. The premise here is that even security agents can be compromised.

This discussion does not provide an exhaustive list of attacks that can be detected using the techniques described herein. Various attacks other than those types discussed herein may be detected and prevented by the solutions described here.

The proposed solution consists of a Zero-Trust Architecture (ZTA) based on a set of distributed security agents that cooperate with each other to detect the occurrence of threat activities and other security events that may indicate a malicious or compromised rApp/xApp. Attacks are created, deployed, and triggered by a threat actor, where an Advanced Persistent Threat (APT), as defined by the National Institute of Standards and Technology (NIST), is a sophisticated threat actor and often state sponsored. A threat actor will employ various tactics, techniques, and procedures (TTP) when performing an attack. Any of these may be considered a “threat,” as defined by NIST. Attacks may exploit known or unknown (zero-day) vulnerabilities to achieve the goal of the attack. The goal of the techniques described herein is to detect TTPs or other suspicious activities that may be connected to an attack. This disclosure does not specify the types of attacks that can be identified—the taxonomy of attacks is outside the scope of the present document as it is unnecessary for a complete understanding of the inventive techniques described herein.

The techniques described herein may be considered as involving an interaction between security agents, which change their behaviors depending on the conditions of the environment (for instance, the RIC). This approach means that security agents are not static, and change their security role according to metrics, which can be regarded as Zero Trust Metrics (ZTMs).

This interaction is focused on predicting the occurrence of attacks, by monitoring ZTMs. An attack-prediction process may be based on the following security phases:
1) A first phase in which Investigation Security Agents (ISAs) are activated to launch an investigation to detect reconnaissance for attacks. Here, the investigation is a monitoring process executed by an ISA against a suspected target, with a goal to determine the relevant features of the reconnaissance that could be used in the future by the suspected target to execute a zero-day attack or/and an APT.
2) A second phase in which Attack Detection Agents (ADAs) can carry out further detection to prevent an external attack from penetrating the network and to prevent the execution of an internal attack (if the threat agent is already within the network).

The techniques described herein take into consideration that the zero-day attacks can come from external attacks or from security agents that can become malicious.

In the following discussion, an indicator of zero-day attacks (defined as reconnaissance activities) is given, to exemplify how an agent can detect the reconnaissance stage of an attack. This is only an indicator and is not exhaustive.

This discussion considers two principal tenets of ZTA, which are “trust nothing and verify everything,” and “adaptive security.” The security agents include the ISA and ADA mentioned above. New ZTA metrics related to the ISA and ADA, ZTM_{ISA} and ZTM_{ADA}, respectively, are introduced with the goal to optimally activate the ISA for launching an investigation to detect reconnaissance of attacks and to optimally activate the ADA to carry further attacks detection and prevent accurately the execution of internal and external attacks (zero-day attacks and APT). In addition, the proposed ZTM_{ISA} and ZTM_{ADA} metrics are used to evaluate the trustworthiness of these agents.

In the use case for Open RAN RIC deployments, rApps and xApps (e.g., as developed by third party specialist software providers) play the role of security agents, monitoring each other and other rApps and xApps for activities indicating either attack reconnaissance or active attacks. Again, however, while the proposed ZTA concept is described herein for rApps and xApps as one of the use cases, the techniques can be used with other sorts of app.

Based on the optimal activation of security agents (ISA and ADA) that accurately detect threats and malicious rApps and xApps, the techniques described herein address the two main principles of ZTA. It is noted that there may be ISA and ADA instances embedded at each rApp and xApp—thus, depending on the monitored ZTA metrics, any given rApp and xApp could play the role of ISA or ADA.

Thus, the ZTA is based on a set of distributed security agents, including one or more investigation security agents (ISAs) and one or more attack detection agents (ADAs). Using common security terminology, the ISA may be considered as operating and detecting threats “left of boom,” while the ADA operates “right of boom”. The ISA performs an investigation process to detect the reconnaissance activities of threat actors before an attack is launched. Then, the ADA executes a specific detection policy (rules-based and/or machine learning-based) to detect attacks or threats. This would include detection through monitoring of the R1 interface, which is the Open RAN interface exposed for use by rApps, to identify command and control (C&C) communications and lateral movement between rApps and between rApps and xApps.

The reconnaissance activities from a potential threat correspond to observable events before an attack is actually performed. Examples of reconnaissance activities are broadcasting unwanted packets or/and removing network packets, before executing the actual attack. These activities may serve as indicators (reconnaissance) of impending attack.

According to the techniques described herein, the activation and/or deactivation of any given ISA or ADA may be done based on a computed and monitored set of ZTA metrics, defined as ZTM_{ISA} and ZTM_{ADA}. These new ZTA metrics allow the optimal activations of security agents (ISA, ADA), and are based on a set of security and network parameters such as Maliciousness Level, Data Redundancy, Data Relevance, Accuracy of Detection, and Attacks Redundancy, as described in further detail below. The techniques described herein Include novel ways to activate and deactivate security agents based on the interactions between the security agents (ISA and ADA).

The rApps and xApps, which may be developed by third party specialist software providers, play the role of distributed security agents, where rApps and xApps may be selectively activated to detect zero-day attacks and APTs, as well as malicious rApps and xApps, while addressing the two main principals of ZTA which are “trust nothing and verify everything”, and “adaptive security.” Key benefits to the solutions described herein include that by optimally activating ISAs and ADAs, TTPs will be detected accurately, i.e., with high detection rates and low false-positive rates, while considering main resource constraints such as computation and communication overheads.

A cooperative security process is executed between the security agents, ISAs and ADAs, to detect accurately the reconnaissance activities before this later executes a cyber/network attack. The security process is activated by ISAs and ADAs to determine accurately the relevant features of reconnaissance activities and prevent the launching of additional cyber/network attacks by detecting and blocking lateral movement and C&C communication.

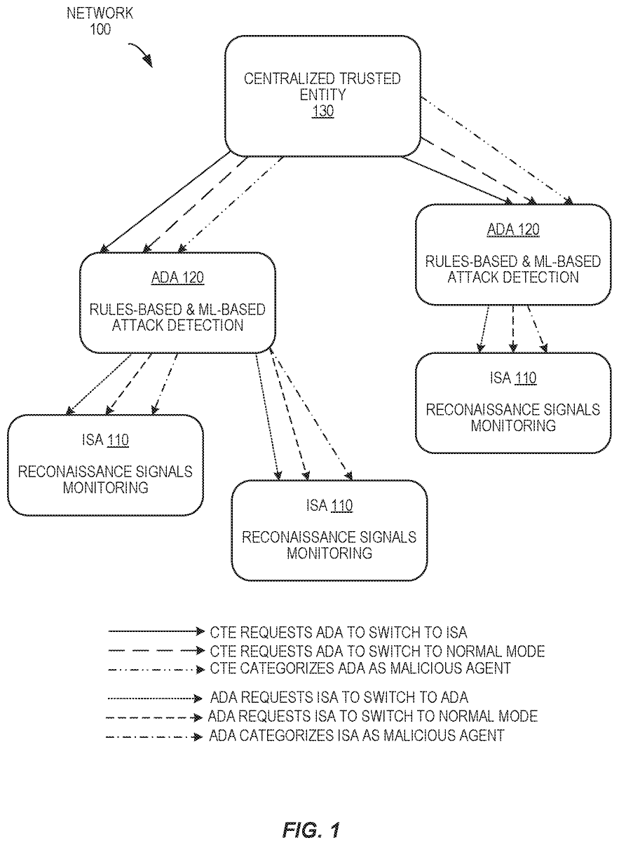

As shown in FIG. 1, a set of security agents are activated within a network 100 to detect security threats and attacks. One, several, or many ISAs 110 and ADAs 120 may be operating (“active”) at any given time. In this illustrated example, each of these forms all or part of or is associated with an rApp or xApp (or other deployable app)—some apps may be capable of being activated as either an ISA or ADA, while others may be capable of only operating as one or the other. The network 100 may also comprise a centralized trusted entity (CTE) 130, which is a node/function known to the operator of the network to be secure and trusted. According to the techniques described herein, ISAs 110 and ADAs 120 may each be individually and selectively activated or deactivated—thus, a given app may be activated as an ISA or ADA at one given time, and not active as either (or active as the other) at another time.

An ISA 110 is responsible for monitoring its neighboring targets, i.e., other apps whose activities it can observe, with a goal to determine the features of reconnaissance activities. These reconnaissance activities correspond to specific observable events before an attack is actually performed. Examples of reconnaissance activities are the broadcasting of unwanted packets or/and the removing of network packets, before executing the actual attack. The number of instances of broadcasting and removing packets may be the relevant features indicating reconnaissance activities. The goal here is to determine, by the ISA 110, the features of reconnaissance activities.

One or more ADAs 120 may each receive from an ISA 110 the features of reconnaissance activities that may be a precursor of a known or suspected new kind of attack. The ADA 120 is configured to monitor for and detect attacks based on rules-based attack detection and machine learning-based attack detection. The rules-based attacks detection technique may be activated first to detect a new kind of attack (started with reconnaissance activities of zero-day attack). However, if a threat is not detected by the rules-based technique, the ADA 120 may switch its detection technique from rules-based to machine learning-based detection to detect accurately a new kind of attack executed by the threat. By switching from lightweight detection technique (i.e., rules-based) to heavy detection technique (i.e., machine learning-based), a tradeoff between computation overhead (and resources consumption) and accuracy of zero-day attacks may be is achieved. The goal here is to detect this new kind of attack by the ADA 120.

According to the principles of ZTA, it must be assumed that any given security agent, whether an ISA or an ADA, can be malicious. The ZTA architecture described here can detect malicious behavior by an agent through the monitoring of certain metrics, defined as ZTM_{ISA} and ZTM_{ADA}.

Each of one or more security agents within the network may have the ability to activate the ISA or ADA based on a Zero-Trust Metric (ZTM) computed by ADA and the centralized trusted entity (such as Security Information and Event Management, SIEM). The computation of the ZTM may be carried out as follows.

The ADA 120 monitors the behavior of its neighbors ISAs 110, with a goal to detect malicious ISAs. This monitoring process consists of computing the ZTM for each monitored ISA, ZTM_{ISA}, where the ZTM may be considered a “reliability metric” for the ISA. Generally speaking, this reliability metric is based on, for each security report sent by the ISA to an ADA, whether or not the report leads to a detected attack and a redundancy of the report. More specifically, as shown in the example formula of Eq. 1, ZTM_{ISA} may be based on a maliciousness level parameter (ML_{ISA}), a data redundancy parameter (DE_{ISA}), and a data relevance parameter (DR_{ISA}), each of which is described in further detail below.

The maliciousness level parameter, which may be defined as ML_{ISA}∈[0,1], increases when the features of suspected attack reconnaissance activities sent by the monitored ISA 110 to the ADA 120 do not allow the ADA 120 to detect the threat (even when the machine-learning based detection is launched and CDA is activated). A suspected attack's reconnaissance features may include, for example, the number of packets sent and dropped (used to detect denial of service (DoS) attacks) and/or the signal strength intensity (used to detect jamming attacks). The data relevance parameter, which may be defined as DR_{ISA}∈[0,1], increases when the features of suspected reconnaissance activities sent by the monitored ISA 110 to an ADA 120 allow the ADA 120 to detect the zero-day attack and APT. The data redundancy parameter, which may be defined as DE_{ISA}∈[0,1], increases when the same features of suspected reconnaissance activities are resent frequently by ISA to ADA.

$${ZTM}_{ISA} = {e}^{{DR}_{ISA}} - ( {e}^{{ML}_{ISA}} + {DE}_{ISA} ) ∈ [ 0 , 1 ] . \qquad ( 1 )$$

It is noted that from Eq. (1), (e^{ML}+DE_{ISA})≤e^{DR}^{_{ISA}}.

The features of suspected reconnaissance activities impact the global security performance. Therefore, exponential functions are used to represent the parameters ML_{ISA} and DR_{ISA} in the example formulation provided by Eq. (1). This means that the value of ZTM_{ISA} increase or decreases rapidly when, respectively, ML_{ISA} and DR_{ISA} increase.

The ADA 120 may send a list of ZTM_{ISAs} related to the monitored ISAs 110 to the centralized trusted entity 130. This latter function may first analyze the maliciousness level of the ADA 120, ML_{ADA}, which is described in detail below, to determine whether to trust, or how to weight, the information provided by that ADA. The centralized trusted entity 130 carries out further detection of TTPs detected by the ADA 120; when the centralized trusted entity 130 confirms the detection of TTPs, the ML_{ADA} decreases, otherwise ML_{ADA} will increase. When the ML_{ADA} is very high, the centralized trusted entity categorizes the ADA 120 as a malicious agent and ignores the list of ZTM_{ISAs} provided by it.

An example computation of ZTM_{ADA} by a centralized trusted entity is defined in Eq. 2. Again, this ZTM may be considered a “reliability metric,” in this case for an ADA. Again, this reliability metric is based on, for each security report sent by the ADA, e.g., to a centralized trust entity or to another ADA, whether or not the report leads to a detected attack and a redundancy of the report. In the example computation shown in Eq. (2), the maliciousness level parameter, which may be defined as ML_{ADA}∈[0,1], increases when the ADA claims that it detects zero-day attacks and the centralized trusted entity does not agree on this detection. An accuracy of detection parameter, which may be defined as AD_{ADA}∈[0,1], corresponds to the number of TTPs or threats detected by the ADA and confirmed by the centralized trusted entity. An attacks redundancy parameter, which may be defined as AR_{ADA}∈[0,1], increases when the same TTP detected by the ADA and not confirmed by centralized trusted entity is resent by the ADA to centralized trusted entity.

$${ZTM}_{ADA} = {e}^{{AD}_{ADA}} - ( {e}^{{ML}_{ADA}} + {AR}_{ADA} ) ∈ [ 0 , 1 ] . \qquad ( 2 )$$

It is noted that in Eq. (2), (e^{ML}^{_{ADA}}+AR_{ADA})≤e^{AD}^{_{ADA}}.

The centralized trusted entity 130 aggregates, over time, the ZTM related to each monitored agent, ZTM_{ISA} and ZTM_{ADA}. Based on the obtained results, the centralized trusted entity may request the security agents to switch from ISA to ADA, switch back from ADA to ISA, or switch from the security agent to a normal mode (i.e., a mode where it does not play the role of ISA or ADA. An example set of thresholds that might be used for triggering these requests is shown in Formula 3.

$$\{ \begin{matrix}ISA switch to ADA & if {ZTM}_{ISA} is close to 1 \\ ADA switch back to ISA & if 0.7 \geq {ZTM}_{ADA} \geq 0.4 \\ ISA switch to normal node & if 0.4 > {ZTM}_{ISA} \geq 0.2 \\ ADA switch to normal node & if 0.4 > {ZTM}_{ADA} \geq 0.2 \\ ISA is a malcious agent & if {ZTM}_{ISA} is close to 0 \\ ADA is a malcious agent & if {ZTM}_{ADA} is close to 0\end{matrix} . \qquad ( 3 )$$

The values in this example are only illustrative, of course. One or more of thresholds may be adaptive, in some embodiments. These thresholds defined in Formula (3) may be defined by the security experts and can be updated over time, depending on the security requirements. The ZTM formulas above may also be varied or modified to ensure a balanced tradeoff between a desired level of security and low network resource cost.

For initialization purposes, e.g., at network deployment, security experts may activate the security agents that play the role of ISA or ADA. The initial assignment of roles depends on the network resources (of the node where the ISA or ADA will be activated) and the trust level of the node. For example, at the beginning, a node that exhibits low network resource consumption (such as energy consumption) and high trust level plays the role of ADA; however, a node that exhibits a high network resource consumption and low trust level plays the role of ISA. Afterward, the roles of security agents may change, according to the computed and monitored ZTM_{ISA} and ZTM_{ADA} metrics.

As explained above, the computation of the ZTM formulas' parameters is done by each security agent (ADA and the centralized trusted entity) and may be summarized as follows:
ML_{ISA} is computed as the number of times that the ISA sends to ADA irrelevant attack's features of suspected reconnaissance activities (where an irrelevant attack's features do not allow the ADA to detect the threat—even when the machine-learning based detection is launched) over the total number of interactions between ISA and ADA.
DR_{ISA} is computed as the number of times that the ISA sends a relevant features of suspected reconnaissance activities to ADA and those relevant features allow ADA to detect unknown attacks (i.e., attack that has not seen before) over the total number of interactions between ISA and ADA.
DE_{ISA} is computed as the number of times that the ISA re-sends to ADA the same features of suspected reconnaissance activities over the total number of interactions between ISA and ADA.
ML_{ADA} is computed as the number of times where the ADA claims that it detects cyber-attacks (such as zero-day attack, APT) and the centralized trusted entity does not agree on this detection over the total number of attacks detected by the centralized trusted entity.
AD_{ADA} is computed as the number of TTPs or threats detected by ADA and confirmed by centralized trusted entity over the total number of TTPs and threats detected by the centralized trusted entity.
AR_{ADA} is computed as the number of times that a report for the same attack detected by ADA and reported to the centralized entity (and not confirmed by the centralized trusted entity) is resent by ADA to centralized trusted entity.

The ZTA techniques described above may be implemented in rApps and xApps, playing the roles of ISAs and ADA. They might also be implemented in deployable apps more generally, in contexts other than the Open RAN as implemented by, for example, operators of 3GPP-compliant telecommunications networks.

In the Open RAN context, however, a RAN Intelligent Controller (RIC) provides an open hosting platform and is responsible for controlling and optimizing the RAN functions. The RIC comes in two forms: Near-Real-Time RIC, sometimes referred to as the real-time RIC, or RT RIC, and the Non-Real-Time RIC, which can be adapted to specific latency or control loop requirements. The RIC can run applications developed by third party specialist software providers. These applications are known as “xApps” and “rApps”, and act as key enablers which run, respectively, at the Near-Real-Time RIC and the Non-Real-Time RIC.

The rApps and xApps may act as security agents to detect attackers targeting the RAN. rApps and xApps can thus play the roles described above for the ISAs and ADAs. The rApps and xApps performing as security agents may be embedded in microservices or act as standalone features.

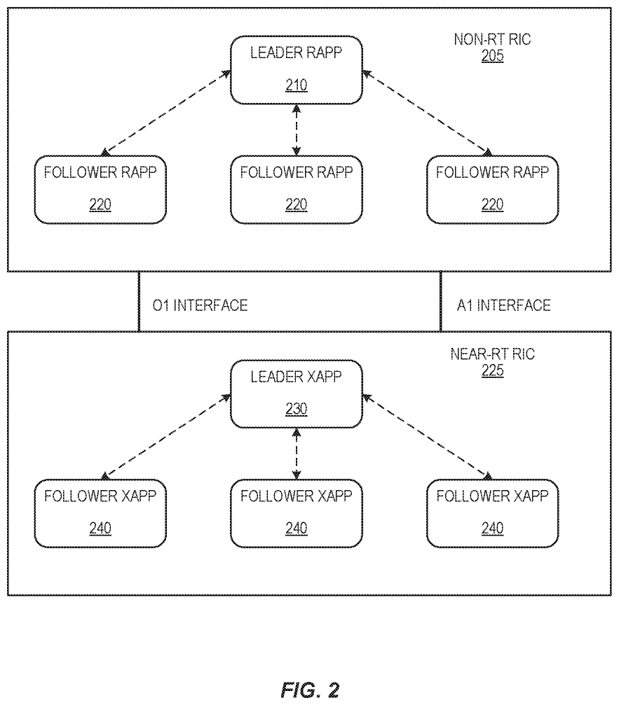

FIG. 2 illustrates an example architecture, in which the Leader rApps 210 and Leader xApps 230 are the ADAs and the Follower rApps 220 and Follower xApps 240 are the ISAs. The Leader rApps and Follower rApps cooperate with each other to monitor the network information (data related to the reconnaissance activities and new attacks launched by zero-day attack) and detection decisions provided by the xApps (that run the ISA and ADA) through the interface A1, between the Non-RT RIC 205 and Near-RT RIC 225. The goal of this monitoring is to allow only xApps that have a high ZTM_{ISA} and ZTM_{ADA} to play the role of ISA and ADA. Thus, this monitoring aims to detect malicious xApps (that act as malicious security agents) and not allow those xApps to play the role of ISA and ADA. This corresponds to when the related ZTMs are very low, for example as shown in Formula 3. This process is applied also to rApps, where the centralized trusted entity, for example, monitors the information and detection decision provided by rApps, by analyzing the ZTMs related to Leader and Follower rApps, ZTM_{ISA} and ZTM_{ADA}.

The Follower rApps 220 and Follower xApps 240 acting as ISAs execute the processes described above to determine the relevant features of reconnaissance activities, and send these features to the respective Leader rApps and xApps that are acting as ADAs. The Leader rApps 210 and Leader xApps 230 run their detection techniques with the goal of detecting new attacks launched by the zero-day attacks.

The ISAs that are activated at follower rApps 220 and follower xApps 240 levels monitor, locally, the behaviors of follower rApps and follower xApps with a goal of detecting the reconnaissance activities related to these suspected rApps and xApps.

There is also a model in which the rApps could play the role of Leader agent for the Follower rApps and Follower xApps. This is achieved via the A1 interface. Here, the Leader rApps plays the role of ADA and the Follower rApps and xApps play the role of ISAs. This adds value to the Non-RT-RIC. Another model is where the Follower rApps act independently from the Leader rApp, while that Leader rApp passively monitors the R1 interface to detect an incident. This model would provide security for rApps that do not support the previous model.

This disclosure focuses on the protection of the R1 and A1 interfaces in the Open RAN, which requires that R1 and A1 traffic to monitored rApps/xApps are mirrored to the agents. Furthermore, the traffic is mirrored after the Transport Layer Security (TLS) contexts on R1 and A1 are terminated. These models serve only as examples, and the list of models is not exhaustive.

Some models of possible implementation functions are provided below. These are not exhaustive, and other models can be realized.

Possible security agent deployment models include:
Security rApps
Security Functions
Embedded Security Agents.

Two or more deployment models may be deployed in combination

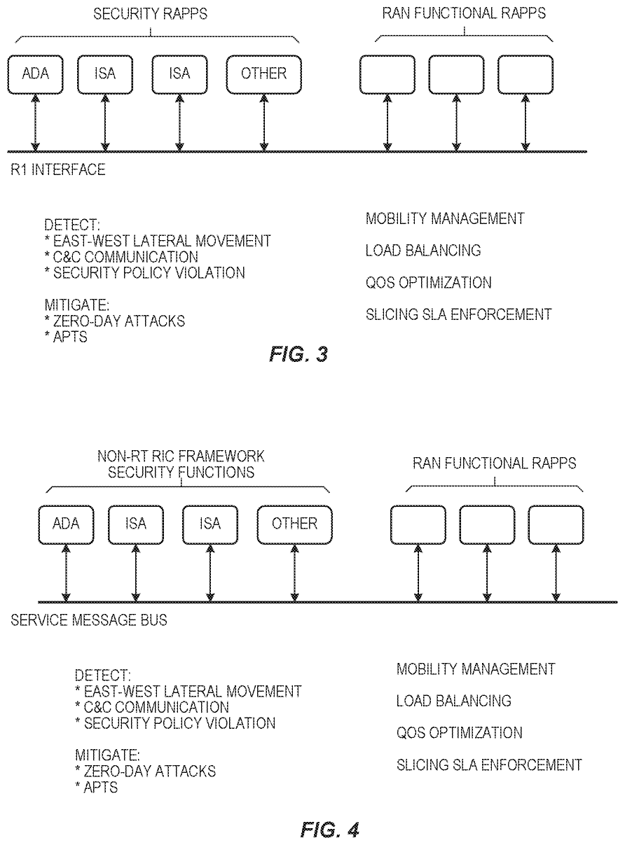

Security rApps—Security agents can be deployed as standalone rApps to detect malicious activity from messaging on the R1 interface, as illustrated in FIG. 3.

Security functions—Security agents can be deployed as standalone Non-RT-RIC Framework Security Functions to detect malicious activity on the Non-RT-RIC Service Message Bus interface, as shown in FIG. 4.

Embedded Security Agents—Security agents can be deployed as embedded agents in Functional rApps to detect malicious activity, as shown in FIG. 5.

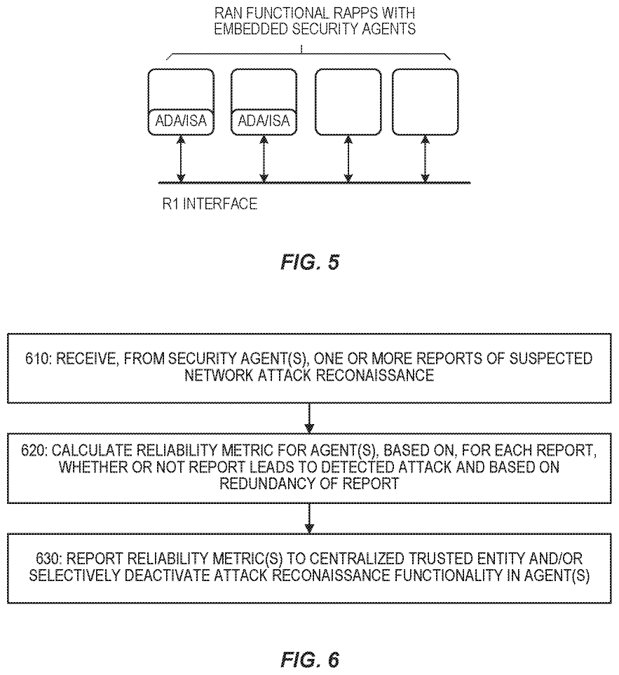

In view of the detailed examples and explanation provided above, FIG. 6 will be understood to illustrate an example method for security, in a deployable app operating in a network, such as an app operating as an ADA. The method shown in FIG. 6 is intended to be a generalization of and to encompass the techniques described above for monitoring the behavior of ISAs, and thus where the terminology used in FIG. 6 and below differs from that used above, the former should be understood to at least encompass the corresponding terminology used above.

As shown at block 610, the method comprises receiving, from a security agent in or associated with a corresponding deployable app in the network, one or more reports of suspected network attack reconnaissance. This security agents may be acting as an ISA, for example, as was discussed in detail above. This step may be performed repeatedly, for the same security agent, in various embodiments or instances, and may be performed for each of multiple such security agents, in some embodiments or instances.

As shown at block 620, the method further comprises calculating a reliability metric for the security agent based on, for each such report received from the security agent, whether or not the report leads to a detected attack and a redundancy of the report. As shown at block 740, the method still further includes reporting the reliability metric for the security agent to a centralized trusted entity and/or selectively deactivating attack detection functionality in the security agent, based on the reliability metric for that agent. Again, each of these steps may be carried out repeatedly, for a given security agent, and/or for each of multiple security agents. Thus, the node or agent carrying out the method shown in FIG. 6 may learn, over time, which security agents performing attack reconnaissance can be relied upon and selectively deactivate those that cannot, which may include malicious agents.

In some embodiments of the illustrated method, the calculating of the reliability metric for the security agent is based on a maliciousness level parameter indicative of a number of times the security agent sends reports of suspected network attack reconnaissance that are not confirmed as corresponding to detected attacks, as well as based on a relevance parameter indicative of a number of times the security agent sends reports of suspected network attack reconnaissance that are confirmed as corresponding to detected attacks. The calculating may be further based on a redundancy parameter indicative of a number of times the security agent sends reports that are duplicative and/or correspond to a same attack or suspected attack. In some embodiments, the reliability metric is calculated according to ZTM_{ISA}=e^{DR}^{_{ISA}}−(e^{ML}^{_{ISA}}+DE_{ISA})∈[0,1], where ZTM_{ISA} is the reliability metric, ML_{ISA}∈[0,1] is the maliciousness level parameter, DR_{ISA}∈[0,1] is the relevance parameter, and DE_{ISA}∈[0,1] is the redundancy parameter.

Some embodiments or instances of the illustrated method comprise deactivating attack reconnaissance functionality in the security agent in response to the calculated reliability metric for the security agent being lower than a predetermined threshold.

These or other embodiments of the illustrated method may further comprise, in response to receiving a report of suspected network attack reconnaissance, evaluating a previously calculated reliability metric for the security agent providing the report and determining whether to launch attack detection efforts in response to the report based on said evaluating.

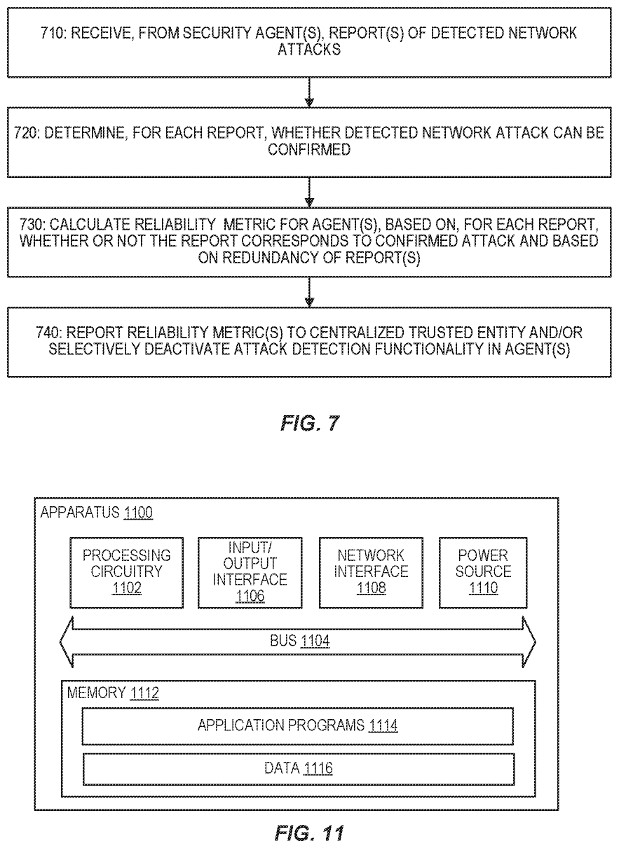

FIG. 7 illustrates a related method for security, as implemented in a centralized functional node in a network. This method is intended to be a generalization of and to encompass the techniques described above for monitoring the behavior of ADAs. Thus, where the terminology used in FIG. 7 and below differs from that used above, the former should be understood to at least encompass the corresponding terminology used above.

As shown at block 710, the method comprises receiving, from a security agent in or associated with a corresponding deployable app in the network, one or more reports of detected network attacks. This security agent may be, for example, an agent acting as an ADA as discussed above. This step may be performed repeatedly, for the same security agent, in various embodiments or instances, and may be performed for each of multiple such security agents, in some embodiments or instances.

The method further comprises, as shown at block 720, the step of determining, for each such report, whether the detected network attack can be confirmed. As shown at block 730, the method comprises calculating a reliability metric for the security agent based on, for each such report received from the security agent, whether or not the report corresponds to a confirmed attack and based on a redundancy of the report. The method still further comprises, as shown at block 740, selectively deactivating attack detection functionality in the security agent, based on the reliability metric for that agent. This may comprise, for example, deactivating attack detection functionality in the security agent in response to the calculated reliability metric for the security agent being lower than a predetermined threshold. As was the case with the previous method, these steps may be carried out repeatedly for a given security agent, and/or for each of multiple security agents. Thus, the node or function carrying out the method shown in FIG. 7 may learn, over time, which security agents performing attack detection can be relied upon and selectively deactivate those that cannot, which may include malicious agents.

In some embodiments or instances, calculating the reliability metric for the security agent is based on a maliciousness level parameter indicative of a number of times the security agent sends reports of detected network attacks that are not confirmed as corresponding to actual attacks and an accuracy of detection parameter indicative of a number of times the security agent sends reports of detected network attacks that are confirmed as corresponding to actual attacks. The calculating may further be based on a redundancy parameter indicative of a number of times the security agent sends reports that are duplicative and/or correspond to the same detected network attack. In some embodiments or instances, the reliability metric is calculated according to ZTM_{ADA}=e^{AD}^{_{ADA}}−(e^{ML}^{_{ADA}}+AR_{ADA})∈[0,1], where ZTM_{ADA} is the reliability metric, ML_{ADA}∈[0,1] is the maliciousness level parameter, AD_{ADA}∈[0,1] is the accuracy of detection parameter, and AR_{ADA}∈[0,1] is the redundancy parameter.

In some embodiments or instances, the method may further comprise, as shown at blocks 750 and 760, the steps of receiving a report of a reliability metric for a reconnaissance security agent engaged in network attack reconnaissance and deactivating the reconnaissance security agent for network attack reconnaissance, based on the received report of the reliability metric. Deactivating the reconnaissance security agent may be further based on one or more additional reports of reliability for the reconnaissance security agent. Thus, it will be appreciated that the entity monitoring and controlling the activation of agents performing attack detection activities may also selectively activate and deactivate agents performing network reconnaissance detection, e.g., based on reports of the latter's reliability received from the former.

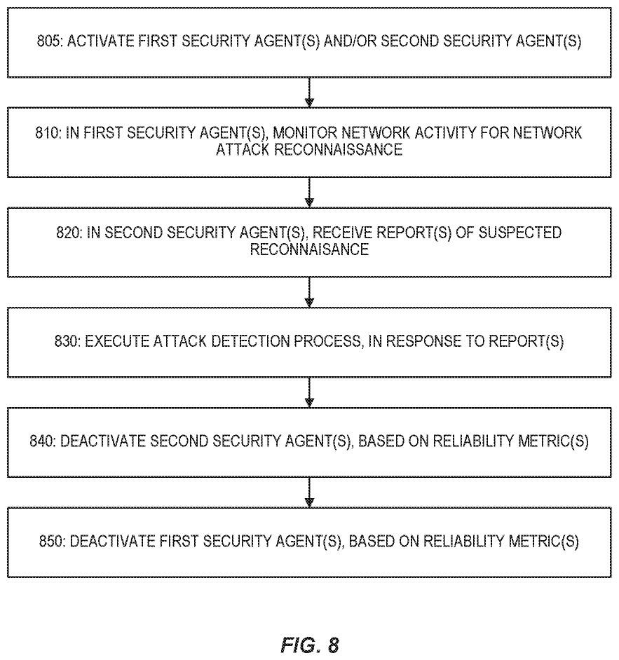

FIG. 8 is a process flow diagram illustrating another example method, according to various implementations of the techniques described herein. The method shown in FIG. 8 is shown at the system level, and thus includes steps and operations carried out by multiple agents, nodes, or other functional elements.

As shown at block 810, the method comprises, in each one or more first security agents in or associated with corresponding one or more deployable apps in the network, monitoring of network activity for suspected network attack reconnaissance. These first security agents may correspond, at least generally, to the ISAs described above. As shown at block 820, the method further comprises, in one or more second security agents in or associated with corresponding one or more deployable apps in the network, receiving one or more reports of suspected network attack reconnaissance from any one or more of the first security agents. These second security agents may correspond, at least generally, to the ADAs described.

As show at block 830, the method further comprises executing an attack detection process, in response to at least one of the one or more reports. In some embodiments or instances, the attack detection process is executed in at least one of the one or more second security agents.

In some embodiments or instances, the method comprises, prior to the monitoring and receiving operations shown at blocks 810 and 820, activating one or more of the second security agents. This activating might be carried out by a centralized trusted entity in the network. Similarly, the method might comprise activating one or more of the first security agents, wherein said activating one or more of the first security agents is carried out by a centralized trusted entity in the network and/or by one or more of the second security agents. These activating operations are shown at block 805 of FIG. 8.

Correspondingly, the method may further comprise, in various embodiments or instances, deactivating one or more of the second security agents. This deactivating may be carried out by a centralized trusted entity in the network, for example, and is shown at block 840. The deactivating may be based on a reliability metric maintained by the centralized trusted entity for each of the second security agents, where the reliability metric for each such second security agent is based on, for each report of a suspected or detected attack received from the second security agent, whether or not the report leads to a confirmed attack and a redundancy of the report. Further details of possible reliability metrics were described above.

Similarly, the method may comprise deactivating one or more of the first security agents. This deactivating, which is shown at block 850 of FIG. 8, may be carried out by a centralized trusted entity in the network and/or by one or more of the second security agents, in various embodiments or instances. This deactivating may be based on a reliability metric for each of the first security agents, for example, where the reliability metric for each such first security agent is based on, for each report of suspected or detected attack reconnaissance received from the first security agent, whether or not the report leads to a detected attack and a redundancy of the report. Again, details of possible reliability metrics were described above.

In various embodiments or instances, at least one of the second security agents is implemented in an rApp, operating in a non-real-time (non-RT) controller portion of the network, e.g., as shown at FIG. 2. In various embodiments or instances, at least one of the first security agents might be implemented in an xApp, operating in a real-time (RT) controller portion of the network, e.g., as also shown in FIG. 2. In some embodiments or instances, the at least one second security agent operating in the non-RT controller portion of the network controls the at least one first security agent operating in the RT controller portion of the network, via the A1 interface.

In some embodiments or instances, at least one of the first security agents and at least one of the second security agents are implemented in respective rApps, monitoring an R1 interface in the network. This is shown in FIG. 3. In some embodiments, at least one of the first or second security agents is implemented as a standalone deployable app, executing only security agent functionality, e.g., as shown in FIG. 3. In some of these and in other embodiments or instances, at least one of the first or second security agents might be implemented as a deployable app executing non-security agent functionality as well as security agent functionality, e.g., as shown at FIG. 5.

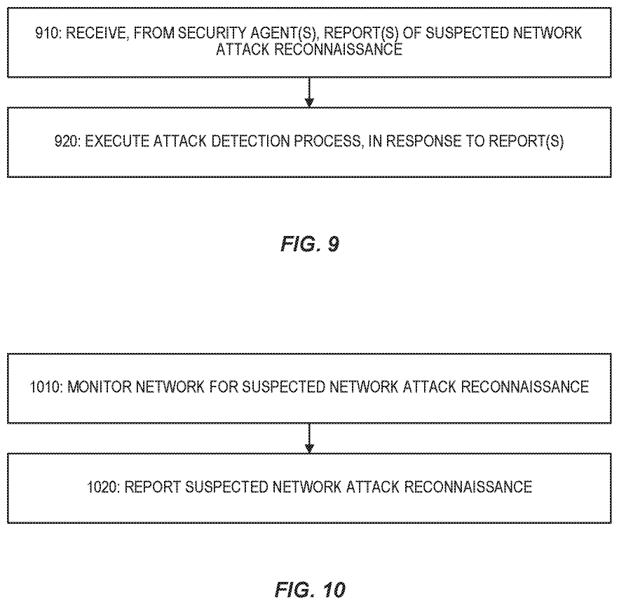

FIG. 9 illustrates another example method, according to various embodiments of the techniques described herein. This method is implemented in a first deployable app operating in a network, e.g., in an rApp or xApp acting as an ADA as was described in detail above.

As shown at block 910, the method of FIG. 9 comprises receiving, from each of one or more security agents in or associated with corresponding one or more other deployable apps in the network, one or more reports of suspected network attack reconnaissance. The method further comprises executing an attack detection process in response to at least one of the one or more reports, as shown at block 920.

In some embodiments or instances, the method illustrated in FIG. 9 may comprise evaluating a respective reliability metric for each of the security agents from which the at least one of the one or more reports are received and determining to execute the attack detection process based on the respective reliability metrics, in addition to the at least one of the one or more reports. These reliability metrics, in some embodiments or instances, may each be based on (a) whether previous reports from the respective security agent led to one or more detected attacks and (b) redundancy of reports previously received from the respective security agent. Thus, these reliability metrics may be any of those described above in connection with FIG. 6, for example, in various embodiments.

In some embodiments or instances, the method may comprise detecting a suspected network attack and reporting the suspected network attack to a centralized trusted entity.

In some embodiments or instances, the method may further comprise deactivating one or more security agents from which reports are received. This deactivating may be based, for example on a reliability metric for each of the security agents. Again, the reliability metric for each such security agent in some embodiments or instances may be based on, for each report of suspected or detected attack reconnaissance received from the security agent, whether or not the report leads to a detected attack and a redundancy of the report.

In various embodiments or instances of the method shown in FIG. 9, the first deployable app, i.e., the app carrying out the method is an rApp, operating in a non-real-time (non-RT) controller portion of the network. In some of these and in some other embodiments or instances, at least one of the security agents from which reports are received may be implemented in an xApp, operating in a real-time (RT) controller portion of the network. In some embodiments or instances, the first deployable app is operating in a non-RT controller portion of the network and controls at least one first security agent operating in the RT controller portion of the network, via the A1 interface.

In some embodiments or instances of the illustrated method, the first deployable app is an rApp, monitoring an R1 interface in the network. In some of these or in other embodiments or instances, the first deployable app is implemented as a standalone deployable app, executing only security agent functionality. In others, the first deployable app is implemented to execute non-security agent functionality as well as security agent functionality.

FIG. 10 illustrates another example method, according to various embodiments of the techniques described herein. This method is implemented in a deployable app operating in a network, e.g., in an rApp or xApp acting as an ISA as was described in detail above. As shown at block 1010, the method comprises monitoring network activity for suspected network attack reconnaissance. As shown at block 1020, the method further comprises reporting suspected network attack reconnaissance to a security agent in or associated with a second deployable app, in response to detecting suspected network attack reconnaissance.

In some embodiments or instances of the method illustrated in FIG. 10, the second deployable app is an rApp, operating in a non-real-time (non-RT) controller portion of the network. In some of these and in some other embodiments or instances, the first deployable app may be an xApp, operating in a real-time (RT) controller portion of the network. Alternatively, the first deployable app may be an rApp, operating in a non-real-time (non-RT) controller portion of the network. In some embodiments or instances, the first deployable app is an rApp monitoring an R1 interface in the network. In various embodiments or instances, the first deployable app may be a standalone deployable app, executing only security agent functionality, or may be implemented to execute non-security agent functionality as well as security agent functionality.

FIG. 11 is a block diagram illustrating an example apparatus configured to carry out one or more of the methods described above. Apparatus 1100 may be or comprise various combinations of hardware and/or software, including a standalone server, a blade server, a cloud-implemented server, a distributed server, a virtual machine, container, or processing resources in a server farm.

Apparatus 1100 includes processing circuitry 1102 that is operatively coupled via a bus 1104 to an input/output interface 1106, a network interface 1108, a power source 1110, and a memory 1112. Other components may be included in other embodiments.

The memory 1112 may include one or more computer programs including one or more application programs 1114 and data 1116. Embodiments of the host 1100 may utilize only a subset or all of the components shown. In some embodiments, application programs 1114 may be implemented in a container-based architecture.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification, drawings and embodiments thereof, can be used synonymously in certain instances, including, but not limited to, e.g., data and information. It should be understood that, while these words and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1-32. (canceled)

33. A method for security in a network, the method comprising:
in a security agent in an xApp, operating in a real-time (RT) controller portion of the network, monitoring network activity for suspected network attack reconnaissance;
in one or more second security agents in or associated with corresponding one or more deployable apps in the network, receiving one or more reports of suspected network attack reconnaissance from the first security agent, and wherein at least one of the second security agents is implemented in an rApp, operating in a non-real-time (non-RT) controller portion of the network; and
executing an attack detection process, in response to at least one of the one or more reports.

34. The method of claim 33, wherein said executing an attack detection process comprises executing the attack detection process in at least one of the one or more second security agents.

35. The method of claim 33, wherein the method further comprises, prior to said monitoring and receiving, activating one or more of the second security agents, wherein said activating is carried out by a centralized trusted entity in the network.

36. The method of claim 33, wherein the method further comprises, prior to said monitoring and receiving, activating one or more of the first security agents, wherein said activating of the first security agent is carried out by a centralized trusted entity in the network and/or by one or more of the second security agents.

37. The method of claim 33, wherein the method further comprises deactivating one or more of the second security agents, wherein said deactivating is carried out by a centralized trusted entity in the network.

38. The method of claim 37, wherein said deactivating is based on a reliability metric maintained by the centralized trusted entity for each of the second security agents, wherein the reliability metric for each such second security agent is based on, for each report of a suspected or detected attack received from the second security agent, whether or not the report leads to a confirmed attack and a redundancy of the report.

39. The method of claim 33, wherein the method further comprises deactivating the first security agent, wherein said deactivating of the first security agent is carried out by a centralized trusted entity in the network and/or by one or more of the second security agents.

40. The method of claim 39, wherein said deactivating of the first security agent is based on a reliability metric for the first security agent, wherein the reliability metric for the first security agent is based on, for each report of suspected or detected attack reconnaissance received from the first security agent, whether or not the report leads to a detected attack and a redundancy of the report.

41. The method of claim 33, wherein the at least one second security agent operating in the non-RT controller portion of the network controls the first security agent, via the A1 interface.

42. The method of claim 33, further comprising monitoring an R1 interface in the network by the at least one second security agent implemented in the rApp.

43. A method for security, in an rApp operating in a non-real-time (non-RT) controller portion of a network, the method comprising:
receiving, from each of one or more security agents in or associated with corresponding one or more xApps, operating in a real-time (RT) controller portion of the network, one or more reports of suspected network attack reconnaissance; and
executing an attack detection process, in response to at least one of the one or more reports.

44. The method of claim 43, wherein the method comprises:
evaluating a respective reliability metric for each of the security agents from which the at least one of the one or more reports are received; and
determining to execute the attack detection process based on the respective reliability metrics, in addition to the at least one of the one or more reports;
wherein each reliability metric is based on (a) whether previous reports from the respective security agent led to one or more detected attacks and (b) redundancy of reports previously received from the respective security agent.

45. The method of claim 43, further comprising detecting a suspected network attack and reporting the suspected network attack to a centralized trusted entity.

46. The method of claim 43, wherein the method further comprises deactivating one or more security agents from which reports are received, wherein said deactivating is based on a reliability metric for each of the security agents, and wherein the reliability metric for each such security agent is based on, for each report of suspected or detected attack reconnaissance received from the security agent, whether or not the report leads to a detected attack and a redundancy of the report.

47. The method of claim 43, wherein the rApp controls the at least one security agent via the A1 interface.

48. The method of claim 43, further comprises monitoring an R1 interface in the network.

49. A method for security, in an xApp operating in a real-time (RT) controller portion of a network, the method comprising:
monitoring network activity for suspected network attack reconnaissance; and reporting suspected network attack reconnaissance to a security agent in or associated with a second deployable app, in response to detecting suspected network attack reconnaissance, wherein the second deployable app is an rApp, operating in a non-real-time (non-RT) controller portion of the network.

50. An apparatus comprising one or more processing circuits and one or respective memory circuits operatively connected to the one or more processing circuits, the memory circuits comprising program instructions for carrying out a method according to claim 33.

51. An apparatus comprising one or more processing circuits and one or respective memory circuits operatively connected to the one or more processing circuits, the memory circuits comprising program instructions for carrying out a method according to claim 43.

52. An apparatus comprising one or more processing circuits and one or respective memory circuits operatively connected to the one or more processing circuits, the memory circuits comprising program instructions for carrying out a method according to claim 49.
